(19) United States
(12) Patent Application Publication
(10) Pub. No.: US 2009/0079873 A1
(43) Pub. Date: Mar. 26, 2009

(54) APPARATUS FOR AND METHOD OF PROCESSING IMAGE SIGNAL AND DISPLAY APPARATUS

(75) Inventor: Masayuki OTAWARA, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/100,101

(22) Filed: Apr. 9, 2008

(30) Foreign Application Priority Data
Sep. 20, 2007 (JP) 2007-244161
Dec. 6, 2007 (KR) 10-2007-0126399

(51) Int. Cl. H04N 5/52

(52) U.S. Cl. 348/678; 348/E05.115

(57) ABSTRACT

Provided are an apparatus for and a method of processing an image signal, a program, and a display apparatus. The apparatus includes: a sub frame generating unit outputting an input signal a plurality of times in one frame period and generating a plurality of sub frames in the one frame period; a correlation judging unit judging a correlation between a current frame which is represented by the input image signal for every sub frame and a preceding frame for every corresponding pixel; and a frame distributing unit adjusting a gain of an image signal corresponding to each pixel for every sub frame on the basis of the correlation judged by the correlation judging unit, and outputting the image signal adjusted for every sub frame in a period corresponding to each of the sub frames.

### CROSS-REFERENCE TO RELATED PATENT APPLICATION

This application claims priority from Japanese Patent Application No. 2007-244161, filed on Sep. 20, 2007 in the Japanese Patent Office, and Korean Patent Application No. 10-2007-0126399, filed on Dec. 6, 2007 in the Korean Intellectual Property Office, the disclosures of which are incorporated herein in their entirety by reference.

### BACKGROUND OF THE INVENTION

1. Field of the Invention

Apparatuses and methods consistent with the present invention relate to an processing an image signal, and a display apparatus.

2. Description of the Related Art

As substitutes for cathode ray tube (CRT) displays, various display devices, such as organic electroluminescenct (EL) displays, organic light emitting diode (OLED) displays, field emission displays (FEDs), liquid crystal displays (LCDs), and plasma display panels (PDPs), have recently been developed.

Display devices may be roughly classified into impulse-type display devices and hold-type display devices according to a light emission method. For example, CRT displays and FEDs are impulse-type display devices that emit light only for a certain persistence period after writing an image, and LCDs are hold-type display devices that hold the display of an image for one frame interval.

Impulse-type display devices and hold-type display devices have different display characteristics. For example, since the impulse-type display devices intermittently emit light, the impulse-type display devices have good assimilation characteristics and less blur that refers to the appearance of an afterimage of a preceding frame, but have a high flicker rate. Since the hold-type display devices continue to display the same image over one frame period, the hold-type display devices offer flicker-free display, but have more blur.

Technologies for ensuring high image quality by suppressing flicker and blur have been developed. A related art technology for suppressing flicker by emitting light twice for one frame period is disclosed in Japanese Unexamined Patent Publication No. 2006-330664, a related art technology for suppressing flicker by interlacing scan lines for one frame period is disclosed in Japanese Unexamined Patent Publication No. 2006-317894, and a related art technology for suppressing the appearance of a double image around moving objects by creating an interpolation frame is disclosed in Japanese Unexamined Patent Publication No. 2006-165974.

However, display devices using the related art technology for suppressing flicker have problems in that since light is always emitted a plurality of times, e.g., twice, during one frame period irrespective of an input image signal, an object may be identifiable as two separate objects due to an afterimage effect seen by human eyes. One of problems that related art display devices using the related art technology for suppressing flicker encounter will now be explained with reference to FIG. 1.

FIGS. 1A and 1B are schematic views for explaining one of problems that a related art display device using a related art technology for suppressing flicker encounters. FIG. 1A illustrates a letter X displayed as a still image on a display screen of the related art display device. FIG. 1B illustrates the letter X displayed as a moving image on the display screen of the related art display device.

Referring to FIG. 1A, when the letter X is displayed as a still image that is formed from a sequence of frames in which there is little or no movement, the related art display device using the related art technology for suppressing flicker does not have a big problem because the position of the letter X is not changed although light is emitted several times for one frame period.

However, referring to FIG. 1B, when the letter X is displayed as a moving image formed from a sequence of frames in which the position of the letter X is changed over time, the letter X in a preceding frame is identifiable by a user as a double image in a current frame due to an afterimage effect. Accordingly, the related art display device using the related art technology for suppressing flicker cannot ensure sufficiently high image quality.

Although the related art technology for suppressing the appearance of a double image has been developed to prevent degradation of image quality, it is difficult to construct an interpolation frame, and when the interpolation frame is not constructed properly, failing to display a moving image, severe distortion occurs in the moving image. Furthermore, as the precision of the interpolation frame increases, costs increase. Accordingly, a display device using the related art technology for suppressing the appearance of a double image cannot ensure sufficiently high image quality.

Since a hold-type display device, such as an LCD, has more blur, the hold-type display device uses such a technology as the related art technology for suppressing the appearance of a double image to prevent blur. In detail, the hold-type display device suppresses blur by emitting light twice for one frame period and interpolating a frame corresponding to second light emission between two sequential frames. However, the related art technology for suppressing blur used by the hold-type display device has a problem in that it is difficult to construct an interpolation frame, often leading to a failure of the construction of the interpolation frame, like in the related art technology for suppressing the appearance of a double image. Accordingly, the hold-type display device using the related art technology for suppressing blur by constructing the interpolation frame cannot ensure sufficiently high image quality.

As described above, the related art technologies for suppressing flicker, blur, and the appearance of a double image cannot ensure sufficiently high image quality.

### SUMMARY OF THE INVENTION

The present invention provides an apparatus for and a method of processing an image signal, a recording medium having embodied thereon a program, and a display apparatus, which can ensure high image quality by judging a correlation between a current frame and a preceding frame on the basis of an input image signal and controlling a gain of an image signal and a light emission time on the basis of the judged correlation.

According to an aspect of the present invention, there is provided an apparatus for processing an image signal, the apparatus comprising: a sub frame generating unit outputting an input signal a plurality of times in one frame period and generating a plurality of sub frames in the one frame period; a correlation judging unit judging a correlation between a current frame which is represented by the input image signal for every sub frame and a preceding frame for every corresponding pixel; and a frame distributing unit adjusting a gain of an image signal corresponding to each pixel for every sub frame on the basis of the correlation judged by the correlation judging unit, and outputting the image signal adjusted for every sub frame in a period corresponding to each of the sub frames.

The apparatus includes the sub frame generating unit, the correlation judging unit, and the frame distributing unit. The sub frame generating unit retains an input image signal for one frame period, and outputs the input image signal in one frame period a plurality of times by reading the retained image signal a plurality of times. Since the sub frame generating unit outputs the input image signal in one frame period a plurality of times, the apparatus can generate a plurality of sub frames in one frame period. The correlation judging unit judges a correlation a current frame and an immediately preceding frame represented by the input image signal for every sub frame. Also, the correlation judging unit judges the correlation for every corresponding pixel when the correlation is displayed on a display screen. The frame distributing unit adjusts a gain of an image signal corresponding to each pixel for every sub frame on the basis of the correlation judged by the correlation judging unit. Also, the frame distributing unit outputs the image signal adjusted for every sub frame in a period corresponding to each of the sub frames.

The frame distributing unit may comprise: an amplifying unit amplifying the input image signal with a predetermined amplification factor; a first switching unit switching the image signal amplified by the amplifying unit, the input image signal, or a signal having a signal level of 0 for every sub frame on the basis of the correlation judged by the correlation judging unit and outputting the switched signal for every sub frame; and a second switching unit outputting the switched signal output for every sub frame from the first switching unit in a period corresponding to each of the sub frames.

The first switching unit may output the input image signal for every sub frame if the correlation judging unit judges that there is a correlation, and output the image signal amplified by the amplifying unit or the signal having the signal level of 0 for every sub frame if the correlation judging unit judges that there is no correlation.

The frame distributing unit may maintain a light output in one frame period at the same level between when it is judged that there is a correlation and when it is judged that there is no correlation.

The correlation judging unit may comprise: a frame memory retaining the input image signal for one frame period; and a comparing unit comparing an image signal corresponding to the current frame with an image signal output from the frame memory and corresponding to the preceding frame for every corresponding pixel.

According to another aspect of the present invention, there is provided an apparatus for processing an image signal, the apparatus comprising: a correlation judging unit judging a correlation between a current frame represented by an input image signal and a preceding frame for every corresponding pixel; a gain adjusting unit adjusting a gain of an image signal corresponding to each pixel on the basis of the correlation judged by the correlation judging unit; a sub frame generating unit outputting the image signal adjusted by and output from the gain adjusting unit a plurality of times in one frame period and generating a plurality of sub frames in the one frame period; and a frame distributing unit outputting the image signal output for every sub frame from the sub frame generating unit in a period corresponding to each of the sub frames.

The apparatus includes the correlation judging unit, the gain adjusting unit, the sub frame generating unit, and the frame distributing unit. The correlation judging unit judges a correlation between a current frame and an immediately preceding frame represented by an input image signal. Also, the correlation judging unit may judge the correlation for every corresponding pixel when the correlation is displayed on a display screen. The gain adjusting unit adjusts a gain of an image signal corresponding to each pixel on the basis of the correlation judged by the correlation judging unit. Also, the gain adjusting unit adjusts a gain of an image signal for every sub frame to correspond to each of the sub frames generated by the sub frame generating unit. The sub frame generating unit may retain the image signal adjusted by the gain adjusting unit corresponding for one frame period and outputs the image signal adjusted by the gain adjusting unit in one frame period a plurality of times by reading the retained image signal a plurality of times. Also, the sub frame generating unit may synchronize the image signals adjusted by the gain adjusting unit and output the synchronized image signals. The frame distributing unit outputs the image signal adjusted for every sub frame in a period corresponding to each of the sub frames.

The gain adjusting unit may comprise: an amplifying unit amplifying the input image signal; and a third switching unit switching the image signal amplified by the amplifying unit, the input image signal, or a signal having a signal level of 0 for every sub frame on the basis of the correlation judged by the correlation judging unit and outputting the switched signal for every corresponding sub frame.

Accordingly, the gain of the input image signal can be adjusted on the basis of the correlation between the current frame and the preceding frame.

The sub frame generating unit may comprise a plurality of sub frame generating means synchronizing and outputting the switched signals output for every corresponding sub frame from the third switching unit a plurality of times in one frame period.

Accordingly, the gain of the image signal and the light emission time can be controlled on the basis of the correlation between the current frame and the preceding frame.

According to another aspect of the present invention, there is provided a method of processing an image signal, the method comprising: outputting an input image signal a plurality of times in one frame period and generating a plurality of sub frames in the one frame period; judging a correlation between a current frame which is represented by the input image signal for every sub frame and a preceding frame for every corresponding pixel; adjusting a gain of an image signal corresponding to each pixel for every sub frame on the basis of the judged correlation of the judging operation; and outputting the image signal adjusted for every pixel frame in a period corresponding to each of the sub frames.

According to another aspect of the present invention, there is provided a method of processing an image signal, the method comprising: judging a correlation between a current frame represented by an input image signal and a preceding frame for every corresponding pixel; adjusting a gain of an image signal corresponding to each pixel on the basis of the judged correlation of the judging operation; outputting the adjusted image signal a plurality of times in one frame period and generating a plurality of sub frames in the one frame period; and outputting the image signal for every sub frame in a period corresponding to each of the sub frames.

According to another aspect of the present invention, there is provided a computer-readable recording medium having embodied thereon a program for executing a method of processing an image signal, the method comprising: outputting an input signal a plurality of times in one frame period and generating a plurality of sub frames in the one frame period; judging a correlation between a current frame which is represented by the input image for every sub frame and a preceding frame for every corresponding pixel; adjusting a gain of an image signal corresponding to each pixel for every sub frame on the basis of the judged correlation; and outputting the image signal adjusted for every sub frame in a period corresponding to each of the sub frames.

According to another aspect of the present invention, there is provided a computer-readable recording medium having embodied thereon a program for executing a method of processing an image signal, the method comprising: judging a correlation between a current frame represented by an input image signal and a preceding frame for every corresponding pixel; adjusting a gain of an image signal corresponding to each pixel on the basis of the judged correlation; outputting the adjusted image signal a plurality of times in one frame period and generating a plurality of sub frames in the one frame period; and outputting the image signal for every sub frame in a period corresponding to each of the sub frames.

According to another aspect of the present invention, there is provided a display apparatus comprising: an image signal adjusting unit adjusting a gain of an image signal and a light emission time in one frame period on the basis of an input image signal; and an image display unit including pixels, which have light emitting elements self-emitting light in response to current and are arranged in matrix, and displaying an image on the basis of the image signal adjusted by the image signal adjusting unit, wherein the image signal adjusting unit comprises: a sub frame generating unit outputting an input image a plurality of times in one frame period and generating a plurality of sub frames in the one frame period; a correlation judging unit judging a correlation between a current frame which is represented by the input image signal for every sub frame and a preceding frame for every corresponding pixel; and a frame distributing unit adjusting a gain of an image signal corresponding to each pixel for every sub frame on the basis of the correlation judged by the correlation judging unit and outputting the image signal adjusted for every sub frame in a period corresponding to each of the sub frames.

The display apparatus includes the image signal adjusting unit and the image display unit. The image signal adjusting unit includes the sub frame generating unit, the correlation judging unit, and the frame distributing unit, and is adapted to judge a correlation between a current frame and a preceding frame and control a gain of an image signal and a light emission time on the basis of the judged correlation. The image display unit displays an image on a display screen on the basis of the image signal adjusted by the image signal adjusting unit. The image display unit may include pixels which have light emitting elements self-emitting light in response to current and are arranged in matrix, and may display an image according to an image signal when current is applied to each pixel according to the image signal.

According to another aspect of the present invention, there is provided a display apparatus comprising: an image signal adjusting unit adjusting a gain of an image signal and a light emission time in one frame period on the basis of an input image signal; and an image display unit including pixels, which have light emitting elements self-emitting light in response to current and are arranged in matrix, and displaying an image on the basis of the image signal adjusted by the image signal adjusting unit, wherein the image signal adjusting unit comprises: a correlation judging unit judging a correlation between a current frame represented by an input image signal and a preceding frame for every corresponding pixel; a gain adjusting unit adjusting a gain of an image signal corresponding to each pixel on the basis of the correlation judged by the correlation judging unit; a sub frame generating unit outputting the image signal adjusted by and output from the gain adjusting unit a plurality of times in one frame period and generating a plurality of sub frames in the one frame period; and a frame distributing unit outputting the image signal output for every sub frame from the sub frame generating unit in a period corresponding to each of the sub frames.

The display apparatus includes the image signal adjusting unit and the image display unit. The image signal adjusting unit includes the correlation judging unit, the gain adjusting unit, the sub frame generating unit, and the frame distributing unit, and is adapted to judge a correlation between a current frame and a preceding frame and control a gain of an image signal and a light emission time on the basis of the judged correlation. The image display unit displays an image on a display screen on the basis of the image signal adjusted by the image signal adjusting unit. The image display unit may include pixels which have light emitting elements self-emitting light in response to current and are arranged in matrix, and may display an image according to an image signal when current is applied to each pixel according to the image signal.

### BRIEF DESCRIPTION OF THE DRAWINGS

The above and other aspects of the present invention will become more apparent by describing in detail exemplary embodiments thereof with reference to the attached drawings in which:

FIGS. 1A and 1B are schematic views for explaining one of problems that a related art display apparatus using a related art technology for suppressing flicker encounters;

FIGS. 2A and 2B illustrate graphs for explaining a control approach of a gain of an image signal and a light emission time according to an exemplary embodiment of the present invention;

FIG. 3 is a block diagram of an apparatus for processing an image signal according to an exemplary embodiment of the present invention;

FIG. 4 is a block diagram of a correlation judging unit of the apparatus of FIG. 3 according to an exemplary embodiment of the present invention;

FIGS. 5A and 5B are block diagrams for explaining the operation of a frame distributing unit of the apparatus of FIG. 3 according to an exemplary embodiment of the present invention;

FIGS. 6A, 6B, 6C and 6D illustrate a schematic diagram and graphs for explaining a relationship between an output of the correlation judging unit and an output of the frame distributing unit of the apparatus of FIG. 3 according to an exemplary embodiment of the present invention;

FIG. 7 is a flowchart illustrating a method of processing an image signal according to an exemplary embodiment of the present invention;

FIG. 8 is a block diagram of an apparatus for processing an image signal according to another exemplary embodiment of the present invention;

FIG. 9 is a flowchart illustrating a method of processing an image signal according to another exemplary embodiment of the present invention; and

FIG. 10 is a block diagram of a display apparatus according to an exemplary embodiment of the present invention.

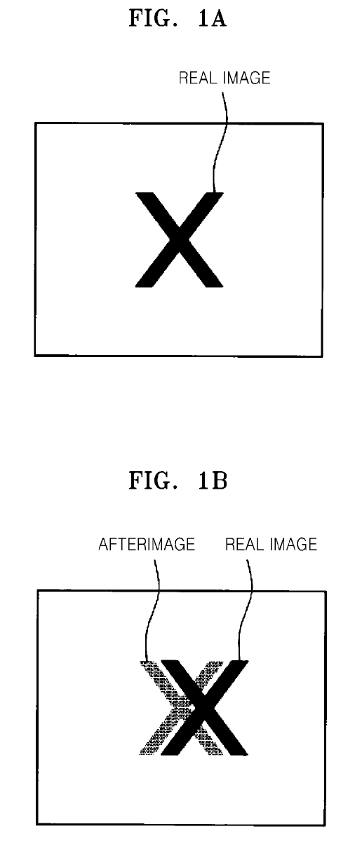

### DETAILED DESCRIPTION OF EXEMPLARY EMBODIMENTS OF THE INVENTION

The present invention will now be described more fully with reference to the accompanying drawings, in which exemplary embodiments of the invention are shown. Elements having the same function and structure are denoted by the same reference numeral, and a repetitive explanation thereof will not be given.

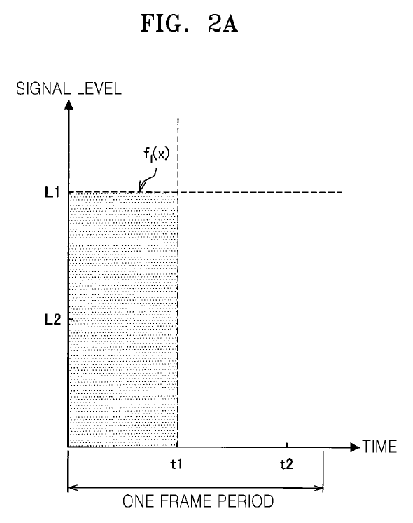

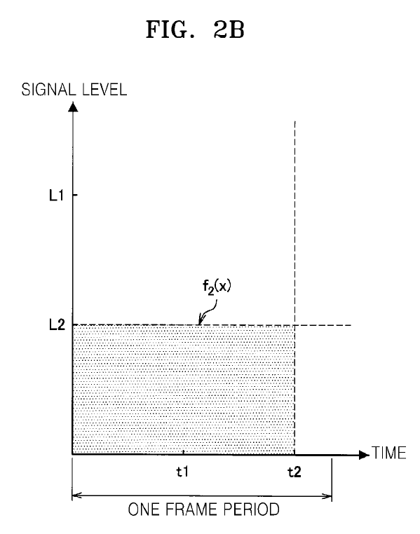

A control approach of a gain of an image signal and a light emission time according to the present invention will be first explained before explaining an apparatus for processing an image signal according to the present invention. FIGS. 2A and B illustrate graphs for explaining a control approach of a gain of an image signal and a light emission time according to an exemplary embodiment of the present invention.

Referring to FIGS. 2A and 2B, a vertical axis represents a signal level of an image signal and a horizontal axis represents a light emission time. FIG. 2A illustrates an impulse-type light emission state. In FIG. 2A, a light output when a signal level is L1 and a light emission time is t1 is L1×t1. FIG. 2B illustrates a hold-type light emission state. In FIG. 2B, a light output when a signal level is L2 (L2<L1) and a light emission time is t2 (t2>t1) is L2×t2.

When the light output in FIG. 2A and the light output in FIG. 2B are equal to each other, that is, when L1×t1=L2×t2, integral equations of FIGS. 2A and 2B are given by Equation 1 as follows:

$${\int }_{0}^{t 1} {f}_{1} ( x ) d t = {\int }_{0}^{t 2} {f}_{2} ( x ) d t . \qquad ( 1 )$$

When Equation 1 is satisfied, that is, when the amounts of light emission in FIGS. 2A and 2B are equal to each other, an image of the same brightness is seen by a user's eyes whether the impulse-type light emission state of FIG. 2A or the hold-type light emission state of FIG. 2B due to the integration effect of human eyes. Accordingly, if the amounts of light emission are equal to each other, whether or not the impulse-type light emission method and the hold-type light emission method are switched, gray scale degradation and image quality degradation can be prevented.

Considering Equation 1, an apparatus for processing an image signal according to the present invention prevents flicker and blur by judging a correlation between a current frame and a preceding frame and controlling a gain of an image signal and a light emission time on the basis of the judged correlation.

(1) Judgement of Correlation between Current Frame and Preceding Frame

The apparatus according to the present invention judges a current frame and an immediately preceding frame represented by an input image signal. By judging the correlation between the current frame and the preceding frame, the apparatus according to the present invention judges whether a subject included in an image represented by the input image signal, such as an animate object (e.g., a person or an animal) or an inanimate object (e.g., a car), is displayed as a still image or a moving image. Although the apparatus according to the present invention judges the correlation for every pixel when the correlation is displayed on a display screen on the basis of the input image signal, the present invention is not limited thereto. For example, the apparatus according to the present invention may divide the display screen into a plurality of regions and judge the correlation for every region. In this case, the apparatus according to the present invention judges a correlation for each of pixels included in a region and determines the mostly likely result as a result of the region.

(2) Control of Gain of Image Signal and Light Emission Time on Basis of Judged Correlation

(2-1) When There is Correlation: When Possibility of Still Image is High

When it is judged there is a correlation between the current frame and the preceding frame, the possibility of a still image is high. Accordingly, the apparatus according to the present invention may select a hold-type light emission method and control a gain of an image signal and a light emission time to have the hold-type light emission state of FIG. 2B.

When a still image is displayed, the risk of blur is low. Accordingly, the apparatus according to the present invention prevents flicker by selecting the hold-type light emission method when the still image is displayed. Accordingly, the apparatus according to the present invention can prevent flicker and blur.

For example, since the Phase Alternating Line (PAL) standard adopted by Europe uses a frame rate of 50 Hz which is lower than a frame rate of 59.94 Hz used by the National Television Standards Committee (NTSC) standard, the PAL standard is susceptible to flicker. However, even when an image signal following the PAL standard is input, the apparatus according to the present invention can prevent flicker by selecting a hold-type light emission method when a still image is displayed.

(2-2) When There is No Correlation: When the possibility of Moving Image is High

When it is judged that there no correlation between the current frame and the preceding frame, the possibility of a moving image is high. Accordingly, the apparatus according to the present invention may select an impulse-type light emission method and controls a gain of an image signal and a light emission time to have the hold-type light emission state of FIG. 2A.

When a moving image is displayed, the risk of flicker is low. Accordingly, the apparatus according to the present invention prevents blur by selecting the impulse-type light emission method. Accordingly, the apparatus according to the present invention can prevent flicker and blur.

The apparatus according to the present invention can prevent flicker and blur by judging the correlation between the current frame and the preceding frame and controlling the gain of the image signal and the light emission time on the basis of the judged correlation. Exemplary embodiments of the apparatus according to the present invention will be explained later in detail.

As a display apparatus for displaying an image signal output from an apparatus for processing an image signal according to the present invention, an organic electroluminescent (EL) display, which self-emits light in response to current flowing through a light emitting element, will be explained. Since an organic EL element, which is the light emitting element included in the organic EL display, has linear current-light output (IL) characteristics, the organic EL element emits light in response to current applied thereto. Accordingly, when the organic EL display is used as the display apparatus for displaying the image signal output from the apparatus for processing the image signal according to the present invention, since a light intensity of a subject represented by the image signal output from the apparatus for processing the image signal and a light intensity of the light emitting element of the display apparatus are in a linear relationship, the image can be displayed on the basis of the image signal.

The display apparatus for displaying the image signal output from the apparatus for processing the image signal according to the present invention is not limited to the organic EL display. For example, the display apparatus according to the present invention may be a display apparatus, which can emit light in response to current flowing through a light emitting element, such as a liquid crystal display (LCD).

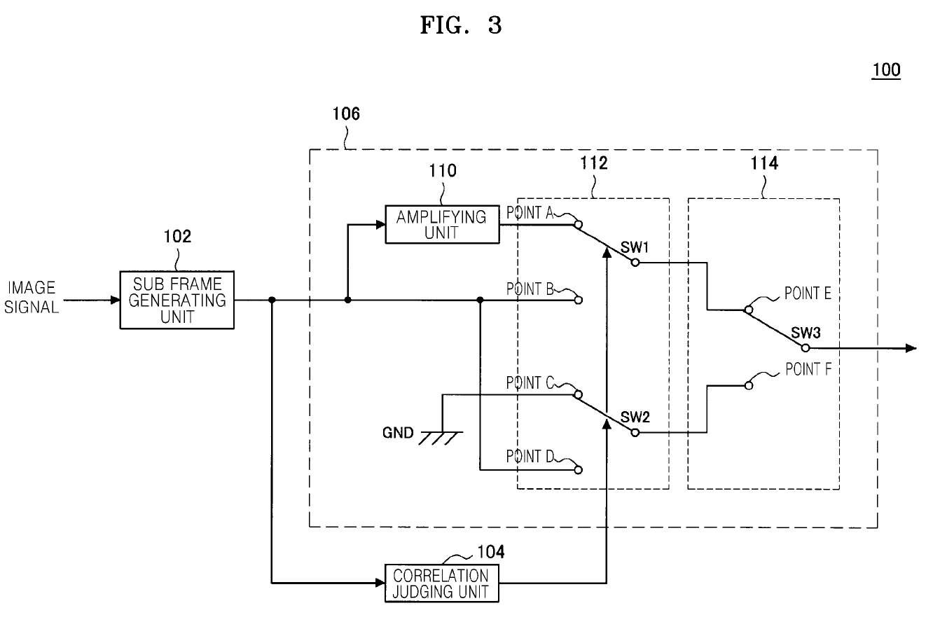

FIG. 3 is a block diagram of an apparatus 100 for processing an image signal according to an exemplary embodiment of the present invention. Although one image signal is input in FIG. 3, the present exemplary embodiment is not limited thereto, and red (R), green (G), and blue (B) image signals may be input.

Although the image signal input to the apparatus 100 is a digital signal used in digital broadcasting or the like, the present exemplary embodiment is not limited thereto, and the image signal may be an analog signal used in analog broadcasting or the like. When the image signal is an analog signal, a sub frame generating unit 102 may include an analog-to-digital (A/D) converter at a front end. Although the image signal input to the apparatus 100 may be transmitted from a broadcasting station, the present exemplary embodiment is not limited thereto. For example, the image signal input to the apparatus 100 may be transmitted via a local area network (LAN) or the like from an external device. Alternatively, the image signal input to the apparatus 100 may be an image file that is retained in a memory of the apparatus 100 and is read by the apparatus 100.

Referring to FIG. 3, the apparatus 100 includes the sub frame generating unit 102, a correlation judging unit 104, and a frame distributing unit 106.

The apparatus 100 may further include a control unit (not shown) including a micro processing unit (MPU) and controlling the overall apparatus 100, a read only memory (ROM, not shown) recording control data, such as programs or operation parameters, used in the control unit, a random access memory (RAM, not shown) temporarily storing programs executed by the control unit, a receiving unit (not shown) receiving an image signal transmitted from a broadcasting station or the like, a control panel (not shown) for user manipulation, and a communication unit (not shown) communicating with an external device (not shown). The apparatus 100 may connect all the above elements by means of a bus that functions as a data transmission path.

The control panel may be an input device, such as a keyboard or a mouse, buttons, direction keys, or a combination thereof. However, the control panel is not limited thereto. The apparatus 100 and the external device may be physically connected to each other via a universal serial bus (USB) or an IEEE 1394 hub, or may be wirelessly connected to each other via a wireless universal serial bus (WUSB) or an IEEE 802.11 hub. The apparatus 100 and the external device may be connected to each other via a network. The network may be a wired network such as LAN or wide area network (WAN), a wireless network using a multiple-input multiple-output (MIMO), or the Internet using a networking protocol such as transmission control protocol/Internet protocol (TCP/IP), but the present exemplary embodiment is not limited thereto. Accordingly, the communication unit has an interface depending on a connection type with the external device.

The sub frame generating unit 102 may include a frame memory and a frame memory controller reading an input image signal from the frame memory a plurality of times in one frame period. The sub frame generating unit 102 generates a plurality of sub frames in one frame period by reading the input image signal in one frame period a plurality of times. For example, referring to FIG. 2, the sub frame generating unit 102 generates a first sub frame t1 and a second sub frame t2−t1 by reading the input image signal twice in one frame period.

Although the sub frame generating unit 102 reads the image signal twice in one frame period, the construction of the apparatus 100 is not limited thereto.

The frame memory may retain an input image signal for one frame period, that is, may retain an image for one screen. The sub frame memory included in the sub frame generating unit 102 is not limited to that structure in which the input image signal for one frame period is retained, but may retain an image of a plurality of frames.

The frame memory controller may include an integrated circuit (IC) and read the image signal retained by the frame memory in one frame period a plurality of times according to a clock signal output from a clock generating unit (not shown). The clock generating unit may include a crystal oscillator and generate a clock signal, but the present exemplary embodiment is not limited thereto. The sub frame generating unit 102 may include the clock generating unit.

The correlation judging unit 104 judges a correlation between a current frame and a preceding frame for every pixel corresponding to a display position at which the correlation is displayed on a display screen on the basis of the image signal output for every sub frame from the sub frame generating unit 102.

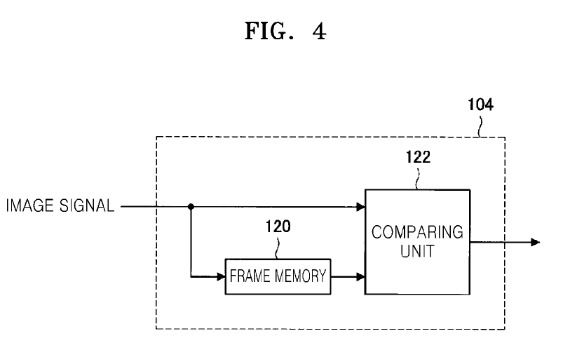

FIG. 4 is a block diagram of the correlation judging unit 104 of the apparatus 100 of FIG. 3 according to an exemplary embodiment of the present invention.

Referring to FIG. 4, the correlation judging unit 104 includes a frame memory 120 and a comparing unit 122.

The frame memory 120 retains an image signal for one frame period, that is, retains an image for one display screen. That is, the frame memory 120 may retain an image signal corresponding to a preceding frame.

The comparing unit 122 compares a signal level of the image signal output for every sub frame from the sub frame generating unit 102 with a signal level of the image signal corresponding to the preceding frame retained in the frame memory 120 for every corresponding pixel. The comparing unit 122 outputs a comparison result for every pixel. The comparing unit 122 may include a comparator, but the present exemplary embodiment is not limited thereto.

The correlation judging unit 104 constructed as shown in FIG. 4 may judge a correlation between a current frame and a preceding frame for every sub frame, and particularly may judge a correlation between a current frame and a preceding frame for every pixel corresponding to a display position at which the correlation is displayed on the display screen.

Referring to FIG. 3 again, the frame distributing unit 106 adjusts an image signal for every sub frame on the basis of the correlation judged by the correlation judging unit 104, and outputs the image signal adjusted for every sub frame in a period corresponding to each of the sub frames. The frame distributing unit 106 includes an amplifying unit 110, a switching unit 112, and a sub frame selecting unit 114.

The amplifying unit 110 may include a digital multiplier and amplify the image signal output for every sub frame from the sub frame generating unit 102 with a predetermined amplification factor. The predetermined amplification factor may be determined according to the number of sub frames. For example, the amplifying unit 110 may amplify a signal level of the image signal with an amplification factor of 2. Although the amplification factor of the amplifying unit 100 may be determined by the number of sub frames, the present exemplary embodiment is not limited thereto. The amplifying unit 100 may have an upper limit of an amplified signal level.

The switching unit 112 adjusts an image signal for every sub frame on the basis of the correlation judged by the correlation judging unit 104. In detail, the switching unit 112 determines an output for every sub frame by switching first and second switches SW1 and SW2 on the basis of the correlation judged by the correlation judging unit 104, and adjusts an image signal for every sub frame. The first switch SW1 corresponds to a first sub frame which is a sub frame of an image signal initially output in one frame period from the sub frame generating unit 102, and the second switch SW2 corresponds to a second sub frame which is a sub frame of an image signal secondly output in the one frame period from the sub frame generating unit 102. The image signal adjusted by and output from the switching unit 112 may be any one of:

(i) an image signal having an amplified signal level output from the amplifying unit 110;

(ii) an image signal input to the apparatus 100 and output from the sub frame generating unit 102; and

(iii) a signal having a signal level of 0.

The signal (i) may be output from the first switch SW1 when the first switch SW1 is connected to a point A. The signal (ii) may be output from each switch when the first switch SW1 is connected to a point B and the second switch SW2 is connected to a point D. The signal (iii) may be output from the second switch SW2 when the second switch SW2 is connected to a point C.

Although the point C is grounded in FIG. 3, the construction of the frame distributing unit 106 is not limited thereto. Although the switching unit 112 includes the two switches SW1 and SW2 in FIG. 3, the present exemplary embodiment is not limited thereto, and the switching unit 112 may include a switch for every pixel corresponding to a display position at which the correlation output from the correlation judging unit 104 is displayed. The following explanation will be made assuming that the switching unit 112 includes the two switches SW1 and SW2.

The sub frame selecting unit 114 includes a third switch SW3 switching an output, and outputs the image signal adjusted for every sub frame in a period corresponding to each of the sub frames. For example, the adjusted signal corresponding to the first sub frame is output from the third switch SW3 when the third switch SW3 is connected to a point E. Also, the adjusted image signal corresponding to the second sub frame is output from the third switch SW3 when the third switch SW3 is connected to a point F. Although the sub frame selecting unit 114 can switch the third switch SW3 in a period corresponding to each of the sub frames generated by the sub frame generating unit 102 by using a clock signal output from the clock generating unit, the present exemplary embodiment is not limited thereto.

The frame distributing unit 106 constructed as shown in FIG. 3 adjusts a gain of an image signal corresponding to each pixel for every sub frame on the basis of the correlation judged by the correlation judging unit 104, and outputs the image signal adjusted for every sub frame in a period corresponding to each of the sub frames. The operation of the frame distributing unit 106 will now be explained in further detail.

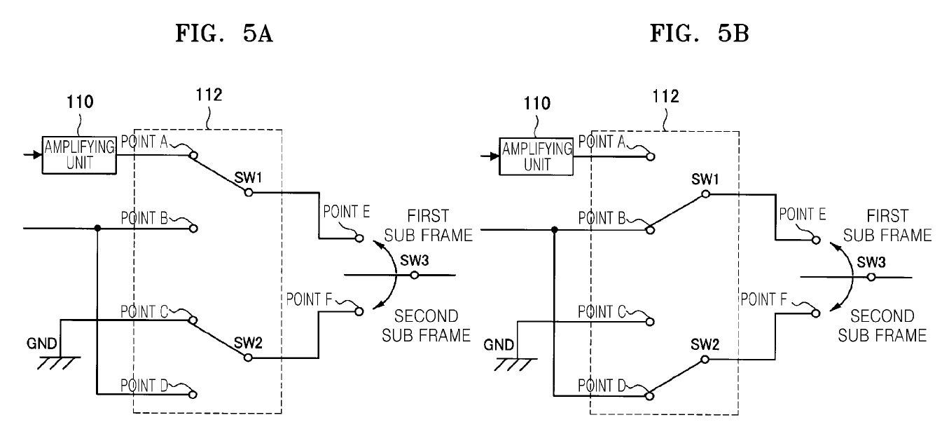

FIGS. 5A and 5B are block diagrams for explaining the operation of the frame distributing unit 106 of the apparatus 100 of FIG. 3 according to an exemplary embodiment of the present invention. FIG. 5A illustrates the first through third switches SW1, SW2, and SW3 when the correlation judging unit 104 judges that there is no correlation between the current frame and the preceding frame, that is, when the input image signal represents a moving image. FIG. 5B illustrates the first through third switches SW1, SW2, and SW3 when the correlation judging unit 104 judges that there is a correlation between the current frame and the preceding frame, that is, when the input image signal represents a still image.

Referring to FIG. 5A, when the correlation judging unit 104 judges that there is no correlation, the first switch SW1 is connected to the point A, and the second switch SW2 is connected to the point C. Accordingly, an image signal having an amplified signal level which corresponds to the signal (i) is output from the first switch SW1, and a signal having a signal level of 0 which corresponds to the signal (iii) is output from the second switch SW2.

The third switch SW3 is connected to the point E in the case of the first sub frame, and outputs the image signal having the amplified signal level which corresponds to the signal (i) and is output from the first switch SW1. The third switch SW3 is connected to the point F in the case of the second sub frame, and outputs the signal having the signal level of 0 which corresponds to the signal (iii) and is output from the second switch SW2.

Accordingly, when the correlation judging unit 104 judges that there is no correlation, the frame distributing unit 106 can have the impulse-type light emission state shown in FIG. 2A.

Referring to FIG. 5B, when the correlation judging unit 104 judges that there is a correlation, the first switch SW1 is connected to the point B, and the second switch SW2 is connected to the point D. Accordingly, an image signal input to the apparatus 100 which corresponds to the signal (ii) is output from the first switch SW1, and an image signal input to the apparatus 100 which corresponds to the signal (ii) is output from the second switch SW2.

The third switch SW3 is connected to the point E in the case of the first sub frame period, and outputs the image signal input to the apparatus 100 which corresponds to the signal (ii) and is output from the first switch SW1. The third switch SW3 is connected to the point F in the case of the second sub frame and outputs the image signal input to the apparatus 100 which corresponds to the signal (ii) and is output from the second switch SW2.

Accordingly, when the correlation judging unit 104 judges that there is a correlation, the frame distributing unit 106 can have the hold-type light emission state shown in FIG. 2B.

A display apparatus for displaying an image signal output from the apparatus 100 may display an image according to an input image signal after dividing a period into a ‘write period’ in which the input image signal is written and a ‘light emission period’ in which current according to the written image signal is applied to each of light emitting elements, e.g., organic EL elements, to emit light.

The apparatus 100 may divide one frame period into a plurality of sub frames including a first sub frame and a second sub frame and output an image signal corresponding to each of the sub frames. Accordingly, the display apparatus for displaying the image signal output from the apparatus 100 has a ‘write period’ and a ‘light emission period’ for every sub frame. However, since the ‘write period’ of the display apparatus for displaying the image signal output from the apparatus 100 is generally much shorter than the ‘light emission period’, it is difficult to recognize the ‘write period’ with human eyes. Also, since the ‘write period’ is very short, even though the ‘write period’ occurs between sub frames, Equation 1 may be approximately satisfied.

Accordingly, the apparatus 100 can have the hold-type light emission state shown in FIG. 2B even when a plurality of sub frames are generated in one frame period. Also, the apparatus 100 can prevent flicker and blur while satisfying Equation 1 by controlling a gain of an image signal and a light emission time on the basis of a correlation between a current frame and a preceding frame.

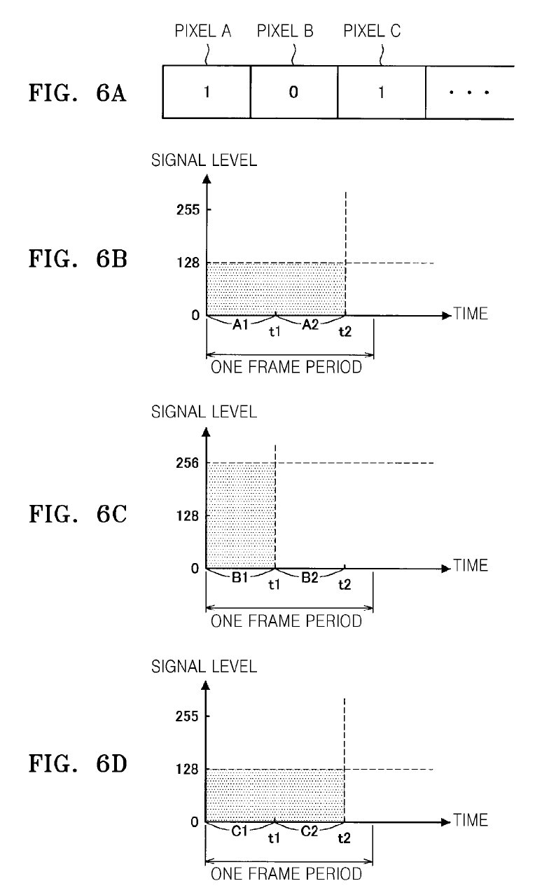

The frame distributing unit 106 operated as shown in FIGS. 5A and 5B can have both the impulse-type light emission state shown in FIG. 2A and the hold-type light emission state shown in FIG. 2B. A relationship between an output of the correlation judging unit 104 and an output of the frame distributing unit 106 of the apparatus 100 will now be explained. FIGS. 6A, 6B, 6C and 6D illustrate a schematic view and graphs for explaining a relationship between an output of the correlation judging unit 104 and an output of the frame distributing unit 106 of the apparatus 100 of FIG. 3 according to an exemplary embodiment of the present invention.

Referring to FIG. 6A, the correlation judging unit 104 may judge a correlation between a current frame and a preceding frame for every pixel corresponding to a display position at which the correlation is displayed on the display screen. Pixels A, B, and C are exemplarily shown, and there is a correlation between the current frame and the preceding frame in the case of the pixels A and C but there is no correlation between the current frame and the preceding frame in the case of the pixel B. The output of the correlation judging unit 104 may be one-bit digital data as shown in FIG. 6A, but the present exemplary embodiment is not limited thereto.

FIG. 6B illustrates a control result of a gain of an image signal and a light emission time corresponding to the pixel A. FIG. 6B illustrates a signal level with a gray scale. Since the correlation judging unit 104 judges that there is a correlation in a display position corresponding to the pixel A, the first and second switches SW1 and SW2 of the frame distributing unit 106 are in the state of FIG. 5B in both the case of a first sub frame A1 and a second sub frame A2. Accordingly, an output of the frame distributing unit 106 that determines the amount of current applied to the pixel A has a hold-type light emission state as shown in FIG. 6B.

FIG. 6C represents a control result of a gain of an image signal and a light emission time corresponding to the pixel B. Since the correlation judging unit 104 judges that there is no correlation at a display position corresponding to the pixel B, the first and second switches SW1 and SW2 of the frame distributing unit 106 are in the state of FIG. 5A in the case of both a first sub frame B1 and a second sub frame B2. Also, the third switch SW3 of the frame distributing unit 106 is switched in a period corresponding to each of the first sub frame B1 and the second sub frame B2. Accordingly, an output of the frame distributing unit 106 that determines the amount of current applied to the pixel B has an impulse-type light emission state as shown in FIG. 6C.

FIG. 6D illustrates a control result of a gain of an image signal and a light emission time corresponding to the pixel C. Since the correlation judging unit 104 judges that there is a correlation at a display position corresponding to the pixel C, the first and second switches SW1 and SW2 of the frame distributing unit 106 are in the state of FIG. 5B in the case of both a first sub frame C1 and a second sub frame C2. Accordingly, an output of the frame distributing unit 106 that determines the amount of current applied to the pixel C has a hold-type light emission state as shown in FIG. 6D.

As shown in FIGS. 6A to 6D, the frame distributing unit 106 can control the gain of the image signal and the light emission time which determine the amount of current applied to each pixel on the basis of the correlation result judged by the correlation judging unit 104, and can switch the light emission state.

As described above, according to the apparatus 100, the sub frame generating unit 102 generates a plurality of sub frames by reading an input image signal a plurality of times, e.g., twice, in one frame period. The correlation judging unit 104 judges a correlation for every pixel corresponding to each display position at which the correlation between a current frame and a preceding frame is displayed for every sub frame. The frame distributing unit 106 adjusts an image signal for every sub frame on the basis of the judged correlation, and outputs the image signal adjusted for every sub frame in a period corresponding to each of the sub frames. In order to prevent blur when the correlation judging unit 104 judges that there is no correlation, the apparatus 100 controls a gain of an image signal and a light emission time to have an impulse-type light emission state. In order to prevent flicker when the correlation judging unit 104 judges that there is a correlation, the apparatus 100 controls a gain of an image signal and a light emission time to have a hold-type light emission state. Accordingly, the apparatus 100 can prevent flicker and blur by judging the correlation between the current frame and the preceding frame on the basis of the input image signal and controlling the gain of the image signal and the light emission time on the basis of the judged correlation.

Also, the apparatus 100 can switch the impulse-type light emission state and the hold-type light emission state while maintaining a light output at the same level by using an integration effect as shown in Equation 1. Accordingly, since there is no change in the light output between before and after the input image signal is processed, the apparatus 100 can prevent image quality degradation.

Accordingly, the apparatus 100 can ensure high image quality by judging the correlation between the current frame and the preceding frame on the basis of the input image signal and controlling the gain of the image signal and the light emission time on the basis of the judged correlation.

Although the apparatus 100 has been exemplarily explained, the present invention is not limited thereto and may be applied to a display apparatus including a light emitting element, which emits light in response to current, such as n organic EL display or an LCD, a computer such as a personal computer (PC) or a server, or a communication device such as a mobile phone. Also, the apparatus 100 may be embodied as an integrated chip (IC) in which the elements of FIG. 3 are integrated. The application to the display apparatus will be explained later.

A computer-readable medium storing a program for embodying the apparatus 100 can ensure high image quality by judging a correlation between a current frame and a preceding frame on the basis of an input image signal and controlling a gain of an image signal and a light emission time on the basis of the judged correlation.

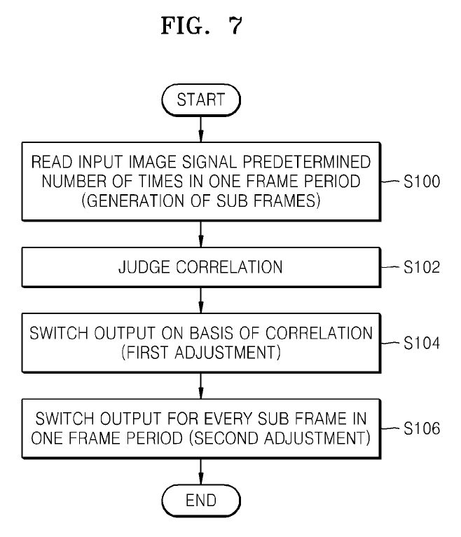

A method of processing an image signal according to an exemplary embodiment of the present invention will now be explained with reference to FIG. 7. The method of processing the image signal of FIG. 7 performed by the apparatus 100 will be explained and may be applied to a display apparatus according to the present invention which will be explained later.

In operation S100, the apparatus 100 retains an input image signal for one frame period (one screen), and reads the image signal a predetermined number of times in one frame period. For example, the apparatus 100 generates a plurality of sub frames in one frame period by reading the input image signal a predetermined number of times in one frame period.

In operation S102, the apparatus 100 judges a correlation between a current frame and a preceding frame for every read image signal, that is, for every sub frame. An image signal read in operation S100 corresponds to an image signal of a current frame, and an image signal which is retained in and read from the frame memory corresponds to an image signal of a preceding frame. The image signal of the preceding frame is not limited to the image signal read from the frame memory. For example, the apparatus 100 may include a delay element delaying an image signal by one frame period, and an image signal output from the delay element may correspond to an image signal of a preceding frame. The judgment in operation S102 may be made for every pixel corresponding to each display position at which the correlation is displayed on the display screen, but the present exemplary embodiment is not limited thereto. The display screen may be divided into a plurality of regions, and the judgment may be made for every region.

In operation S104, the apparatus 100 switches an output for every sub frame on the basis of the correlation judged in operation S102 and adjusts an image signal for every sub frame. In detail, in operation S104, the apparatus 100 may adjust a signal level of the image signal so as to satisfy Equation 1. Also, the output switched in operation S104 may be any one of:
(i) an image signal having an amplified signal level;
(ii) an image signal input to the apparatus 100; and
(iii) a signal having a signal level of 0.

In operation S106, the apparatus 100 switches the image signal adjusted for every sub frame in operation S104 in a period corresponding to each of the sub frames and outputs the switched image signal. In detail, in operation S106, the apparatus 100 may adjust a light emission time so as to satisfy Equation 1.

As shown in FIG. 7, the method generates the plurality of sub frames in one frame period, adjusts the signal level of the image signal for every sub frame on the basis of the correlation between the current frame and the preceding frame, and outputs the adjusted image signal in the period corresponding to each of the sub frames. Accordingly, the apparatus 100 using the method of FIG. 7 can prevent flicker and blur by switching the impulse-type light emission state of FIG. 2A and the hold-type light emission state of FIG. 2B on the basis of the correlation between the current frame and the preceding frame.

Accordingly, the apparatus 100 using the method of FIG. 7 can ensure high image quality by judging the correlation between the current frame and the preceding frame on the basis of the input image signal and controlling the gain of the image signal and the light emission time on the basis of the judged correlation.

The apparatus 100 of FIG. 3, which generates the sub frames, judges the correlation between the current frame and the preceding frame for every generated sub frame, and controls the gain of the image signal and the light emission time on the basis of the judged correlation, has been explained. An apparatus for processing an image signal according to the present invention is not limited thereto and an apparatus for processing an image signal according to another exemplary embodiment of the present invention will now be explained.

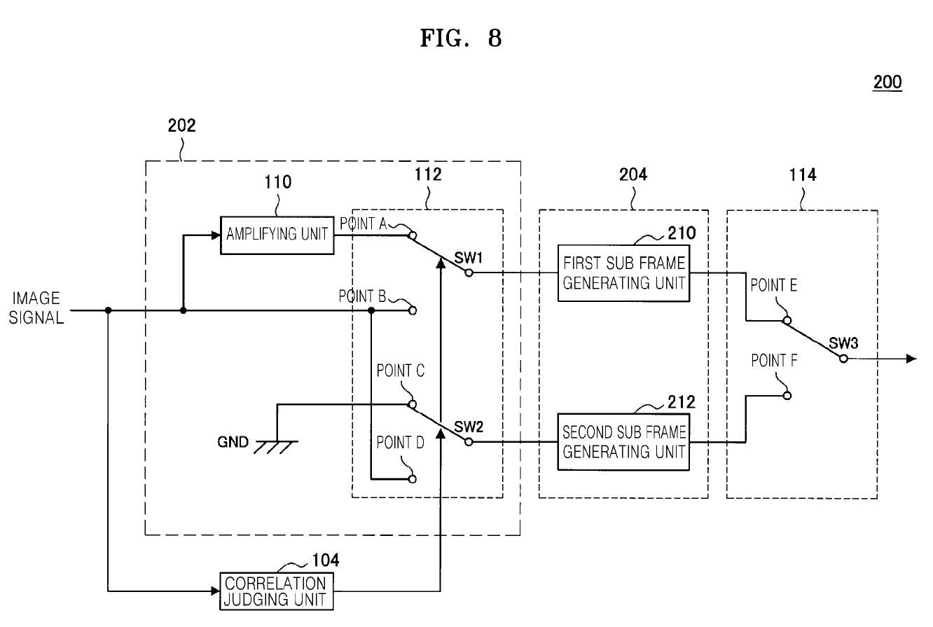

FIG. 8 is a block diagram of an apparatus 200 for processing an image signal according to another exemplary embodiment of the present invention. Although the apparatus 200 of FIG. 8 generates a first sub frame and a second sub frame in one frame period, similar to the apparatus 100, the construction of the apparatus 200 is not limited thereto.

Referring to FIG. 8, the apparatus 200 includes a correlation judging unit 104, a gain adjusting unit 202, a sub frame generating unit 204, and a sub frame selecting unit 114.

Similar to the apparatus 100 of FIG. 3, the apparatus 200 of FIG. 8 may further include a control unit (not shown) including an MPU and controlling the overall apparatus 200, a ROM (not shown) recording control data, such as programs or operation parameters, used in the control unit, a RAM (not shown) temporarily storing programs executed by the control unit, a receiving unit (not shown) receiving an image signal transmitted from a broadcasting station or the similar to, a control panel (not shown) for user manipulation, and a communication unit (not shown) communicating with an external device (not shown).

Similar to the correlation judging unit 104 of the apparatus 100 shown in FIG. 3, the correlation judging unit 104 of the apparatus 200 of FIG. 8 judges a correlation between a current frame and a preceding frame for every pixel corresponding to each display position at which the correlation is displayed on a display screen on the basis of an input image signal.

The gain adjusting unit 202 includes an amplifying unit 110 and a switching unit 112. Similar to the amplifying unit 110 of the apparatus 100 of FIG. 3, the amplifying unit 110 of the apparatus 200 of FIG. 8 amplifies the input image signal with a predetermined amplification factor. Similar to the switching unit 112 of the apparatus 100 of FIG. 3, the switching unit 112 of the apparatus 200 of FIG. 8 includes a first switch SW1 switching an output corresponding to a first sub frame and a second switch SW2 switching an output corresponding to a second sub frame, and adjusts an image signal for every sub frame on the basis of the correlation judged by the correlation judging unit 104. Thee image signal adjusted by and output from the switching unit 112 may be any one of:
(iv) an image signal having an amplified signal level;
(v) an image signal input to the apparatus 200; and
(vi) a signal having a signal level of 0.

The signal (iv) may be output from the first switch SW1 when the first switch SW1 is connected to a point A. The signal (v) may be output from each switch when the first switch SW1 is connected to a point B and the second switch SW2 is connected to a point D. The signal (vi) may be output from the second switch SW2 when the second switch SW2 is connected to a point C.

The sub frame generating unit 204 includes a first sub frame generating unit 210 corresponding to the first switch SW1 included in the switching unit 112, and a second sub frame generating unit 212 corresponding to the second switch SW2 included in the switching unit 112. The apparatus 200 is different from the apparatus 100 in that the apparatus 200 includes the sub frame generating units which correspond in number to the number of generated sub frames. Since the apparatus 200 does not generate sub frames at a front end of the sub frame generating unit 204, the correlation judging unit 104 and the gain adjusting unit 202 do not require a processing speed as high as a change of sub frames.

Each of the first sub frame generating unit 210 and the second sub frame generating unit 212 of the apparatus 200 of FIG. 8 has the same construction as that of the sub frame generating unit 102 of the apparatus 100 of FIG. 3. Accordingly, each of the first sub frame generating unit 210 and the second sub frame generating unit 212 generates a plurality of sub frames in one frame period by reading an input image signal a plurality of times, e.g., twice, in one frame period. Also, each of the first sub frame generating unit 210 and the second sub frame generating unit 212 may synchronize the generated sub frames by generating the sub frames according to a clock signal output from a clock generating unit (not shown).

The sub frame selecting unit 114 includes a third switch SW3, switches an output from the first sub frame generating unit 210 or an output from the second sub frame generating unit 212 in a period corresponding to each of the generated sub frames, and outputs the switched output. In further detail, the sub frame selecting unit 114 connects the third switch SW3 to a point E of the first sub frame generating unit 210 in a period corresponding to a first sub frame, and connects the third switch SW3 to a point F of the second sub frame generating unit 212 in a period corresponding to a second sub frame. Since the sub frame selecting unit 114 of the apparatus 200 of FIG. 8 has the same function as that of the sub frame selecting unit 114 of the frame distributing unit 106 of the apparatus 100 of FIG. 3, the sub frame selecting unit 114 of the apparatus 200 of FIG. 8 may serve as a frame distributing unit.

Accordingly, the sub frame selecting unit 114 outputs an output from the first sub frame generating unit 210 in a period corresponding to a first sub frame and outputs an output from the second sub frame generating unit 212 in a period corresponding to a second sub frame. The sub frame selecting unit 114 may switch the third switch SW3 according to a clock signal output from the clock generating unit.

Similar to the apparatus 100 of FIG. 3, the apparatus 200 of FIG. 8 can control a gain of an image signal and a light emission time which determine the amount of current applied to each pixel on the basis of the correlation judged by the correlation judging unit 104, and can switch a light emission state.

Also, according to the apparatus 200, the switching unit 112 adjusts an image signal for every sub frame on the basis of the correlation judged by the correlation judging unit 104 and outputs the image signal adjusted for every sub frame in a period corresponding to each of the sub frames. Accordingly, similar to the apparatus 100 of FIG. 3, the apparatus 200 of FIG. 8 can control the gain of the image signal and the light emission time on the basis of the correlation between the current frame and the preceding frame so as to satisfy Equation 1.

As described above, according to the apparatus 200, the correlation judging unit 104 judges the correlation between the current frame and the preceding frame for every pixel corresponding to each display position at which the correlation is displayed on the display screen for the input image. The gain adjusting unit 202 adjusts an image signal corresponding to each of the generated sub frames on the basis of the correlation judged by the correlation judging unit 104 and outputs the adjusted image signal for every sub frame. The sub frame generating unit 204 generates the plurality of sub frames by synchronizing and reading image signals output from the gain adjusting unit 202 a plurality of times, e.g., twice, in one frame period. The frame distributing unit 114 outputs the adjusted image signal for every sub frame in a period corresponding to each of the sub frames. Similar to the apparatus 100 of FIG. 3, in order to prevent blur when the correlation judging unit 104 judges that there is no correlation, the apparatus 200 of FIG. 8 controls the gain of the image signal and the light emission time to have an impulse-type light emission state, and in order to prevent flicker when the correlation judging unit 104 judges that there is a correlation, the apparatus 200 of FIG. 8 controls the gain of the image signal and the light emission time to have a hold-type light emission state. Accordingly, the apparatus 200 can prevent flicker and blur by judging the correlation between the current frame and the preceding frame on the basis of the input image signal and the gain of the image signal and the light emission time on the basis of the judged correlation.

Also, similar to the apparatus 100 of FIG. 3, the apparatus 200 of FIG. 8 can switch the impulse-type light emission state and the hold-type light emission state while maintaining a light output at the same level by using an integration effect as shown in Equation 1. Because there is no change in the light output between before and after the input image signal is processed, the apparatus 200 can prevent image quality degradation.

Accordingly, similar to the apparatus 100, the apparatus 200 can ensure high image quality by judging the correlation between the current frame and the preceding frame on the basis of the input image signal and controlling the gain of the image signal and the light emission time on the basis of the judged correlation.

Although the apparatus 200 has been exemplarily explained, the present invention is not limited thereto and may be applied to a display apparatus including a light emitting element, which emits light in response to current, such as an organic EL display or an LCD, a computer such as a PC or a server, or a communication device such as a mobile phone. Also, similar to the apparatus 100 of FIG. 3, the apparatus 200 of FIG. 8 may be embodied as an IC in which the elements of FIG. 8 are integrated.

A computer-readable medium storing a program for embodying the apparatus 200 can ensure high image quality by judging a correlation between a current frame and a preceding frame on the basis of an input image signal and controlling a gain of an image signal and a light emission time on the basis of the judged correlation.

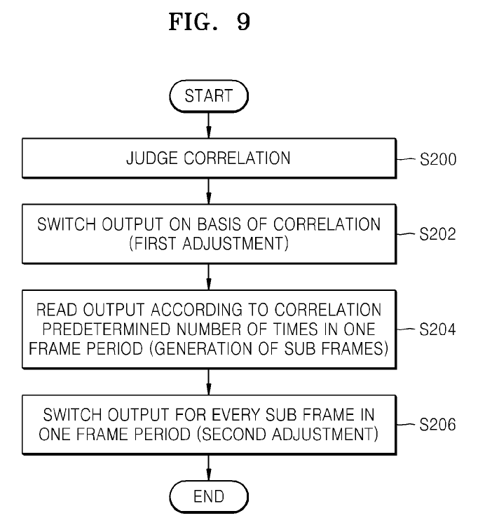

A method of processing an image signal according to an exemplary embodiment of the present invention will now be explained with reference to FIG. 9. The method of processing the image signal of FIG. 9 performed by the apparatus 200 will be explained and may be applied to a display apparatus according to the present invention which will be explained later.

In operation S200, the apparatus 200 judges a correlation between a current frame and a preceding frame of an input image signal. An image signal read in operation S200 corresponds to an image signal of a current frame, and an image signal which is retained in and read from a frame memory corresponds to an image signal of a preceding frame. The image signal of the preceding frame is not limited to the image signal read from the frame memory. For example, the apparatus 200 may include a delay element delaying an image signal by one frame period, and an image signal output from the delay element may correspond to an image signal of a preceding frame. The judgment in operation S200 may be made for every pixel corresponding to each display position at which the correlation is displayed on a display screen, but the present exemplary embodiment is not limited thereto. The display screen may be divided into a plurality of regions, and the judgment may be made for every region.

In operation S202, the apparatus 200 switches an output for every sub frame on the basis of the correlation judged in operation S200 and adjusts an image signal for every sub frame. In detail, in operation S202, the apparatus 200 may adjust a signal level of the image signal so as to satisfy Equation 1. Also, the output switched in operation S202 may be any one of:
(iv) an image signal having an amplified signal level;
(v) an image signal input to the apparatus 200; and
(vi) a signal having a signal level of 0.

In operation S204, the apparatus 200 retains an output for one frame period (one period) according to the correlation judged in operation S202 and reads the output a predetermined number of times in one frame period. For example, the apparatus 200 generates a plurality of sub frames in one frame period by reading the output according to the correlation judged in operation S202 a predetermined number of times in one frame period. Also, the apparatus 200 may synchronize and read outputs according to operation S202 in operation S204.

In operation S206, the apparatus 200 switches the image signal adjusted in operation S202 in a period corresponding to each of the generate sub frames. In detail, in operation S206, the apparatus 200 may adjust a light emission time so as to satisfy Equation 1.

As shown in FIG. 9, the method adjusts the signal level of the image signal to correspond to each of the generated sub frames on the basis of the correlation between the current frame and the preceding frame on the basis of the input image signal. The method generates the plurality of sub frames in one frame period by synchronizing and reading the adjusted image signals a plurality of times in one frame period, switches the adjusted image signals in periods corresponding to the respective sub frames, and outputs the switched image signals. Although the method of FIG. 9 is different in the order of operation of processing an image signal and generating sub frames from the method of FIG. 7, the method of FIG. 9 adjusts the signal level of the image signal to correspond to each of the generated sub frames, switches the adjusted image signal in the period corresponding to each of the sub frames, and outputs the switched image signal. Accordingly, the apparatus 200 using the method of FIG. 9 can switch the impulse-type light emission state of FIG. 2A and the hold-type light emission state of FIG. 2B on the basis of the correlation between the current frame and the preceding frame. Accordingly, the apparatus 200 using the method of FIG. 9 can prevent flicker and blur, similar to the apparatus 100.

Accordingly, the apparatus 200 using the method of FIG. 9 can ensure high image quality by judging the correlation between the current frame and the preceding frame on the basis of the input image signal and controlling the gain of the image signal and the light emission time on the basis of the judged correlation.

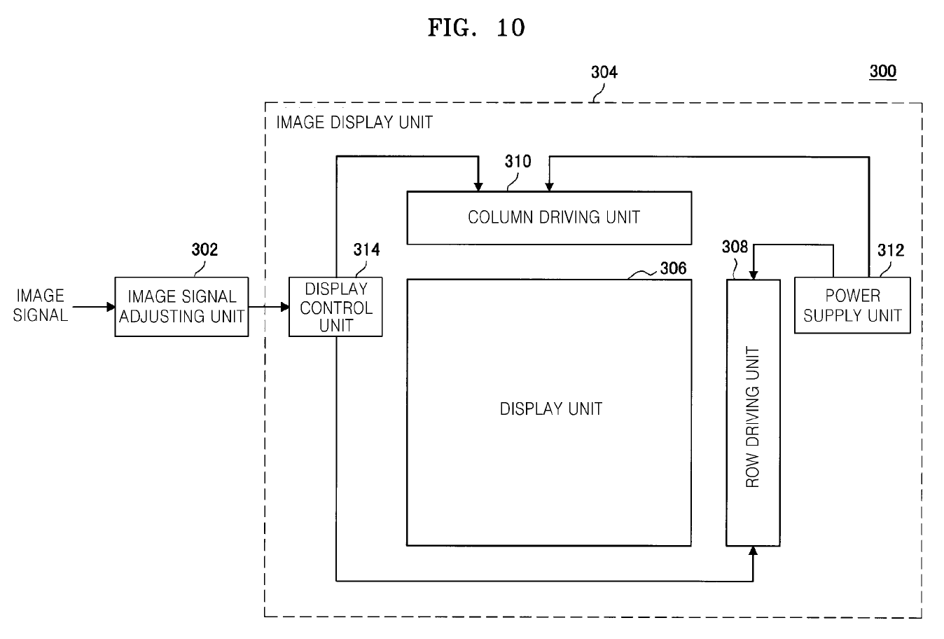

A display apparatus using an apparatus for processing an image signal according to the present invention will now be explained with reference to FIG. 10. The display apparatus 300 is an example of a display apparatus according to the present invention, and the present invention is not limited to the construction of the display apparatus 300 of FIG. 10. Although an image signal input to the display apparatus 300 is a digital signal used in digital broadcasting or the like, the present exemplary embodiment is not limited thereto and the image signal input to the display apparatus 300 may be an analog signal used in analog broadcasting or the like.

An organic EL display, which self-emits light in response to current flowing through a light emitting element, will be exemplarily explained as the display apparatus 300. The present exemplary embodiment is not limited to the organic EL display, and a display apparatus self-emitting in response to current flowing through a light emitting element, such as an LCD, may be used.

Referring to FIG. 10, the display apparatus 300 includes an image signal adjusting unit 302 and an image display unit 304.

The display apparatus 300 may further include a control unit (not shown) including an MPU and controlling the overall display apparatus 300, a ROM (not shown) recording control data, such as programs or operation parameters, used in the control unit, a RAM (not shown) temporarily storing programs executed by the control unit, a memory unit (not shown) storing various data including display data for user interface, a receiving unit (not shown) receiving an image signal transmitted from a broadcasting station or the like, a control panel (not shown) for user manipulation, and a communication unit (not shown) communicating with an external device (not shown). The display apparatus 300 may connect all the above elements by means of a bus that functions as a data transmission path.

The memory unit may be a magnetic recording medium, such as a hard disk, or a non-volatile memory, such as an electronically erasable and programmable read only memory (EEPROM), a flash memory, a magnetoresistive random access memory (MRAM), a ferroelectric random access memory (FeRAM), or a phase change random access memory (PRAM), but the present exemplary embodiment is not limited thereto. The control panel may be an operation input device, such as a keyboard or a mouse, buttons, direction keys, or a combination thereof, but the present exemplary embodiment is not limited thereto. The display apparatus 300 and the external device may be connected to and communicate with each other in a wired or wireless manner.

The image signal adjusting unit 302 may have the same construction as that of the apparatus 100 of FIG. 3 or that of the apparatus 200 of FIG. 8. Accordingly, the image signal adjusting unit 302 can judge a correlation between a current frame and a preceding frame on the basis of an input image signal and control a gain of an image signal and a light emission time on the basis of the judged correlation.

The image display unit 304 displays an image on the basis of the image signal adjusted by the image signal adjusting unit 302.

The image display unit 304 includes a display unit 306, a row driving unit 308, a column driving unit 310, a power supply unit 312, and a display control unit 314.

The display unit 306 includes a plurality of pixels arranged in matrix. For example, when displaying a standard definition (SD) image, the display unit 306 includes at least 307200 pixels (=640 data lines×480 scan lines), and when displaying a color image including red, green, and blue sub pixels, the display unit 306 includes 921600 sub pixels (=640 data lines×480 scan lines×3 sub pixels). Likewise, when displaying a high definition (HD) image, the display unit 306 includes 1920×1080 pixels, and when displaying a color image, the display unit 306 includes 1920×1080×3 sub pixels.

When a light emitting element having sub pixels of each pixel is an organic EL element, the organic EL element has linear IL characteristics and thus emits light in response to current applied thereto. Accordingly, when an organic EL display is used as the display apparatus 300, since a light intensity of a subject represented by an adjusted image signal and a light intensity of the light emitting element of the display apparatus 300 are in a linear relationship, an image can be displayed on the basis of the image signal. The organic EL element is a light emitting element self-emitting light due to an electroluminescence. The electroluminescence is a phenomenon where electric energy in a material (organic EL element) changes from a ground state to an excited state due to an electric field and is emitted as light when returning from the unstable excited state to the stable ground state.

The display unit 306 may include a pixel circuit (not shown) controlling the application of voltage or current for every pixel. The pixel circuit may include a switch element and a drive element controlling the amount of current by using a scan signal and a voltage signal, and a capacitor retaining the voltage signal. The switch element and the drive element may include a thin film transistor (TFT).

The row driving unit 308 and the column driving unit 310 may scan each of the pixels included in the display unit 306 by applying a voltage signal to the pixels. Any one of the row driving unit 308 and the column driving unit 310 applies a voltage signal (scan signal) that determines whether to turn on or off a pixel, and the remaining one of the row driving unit 308 and the column driving unit 310 applies a voltage signal (image signal) according to an image to be displayed.

Each of the row driving unit 308 and the column driving unit 310 may use a dot-sequential scanning method scanning the pixels arranged in matrix pixel by pixel, a line-sequential scanning method scanning the pixels arranged in matrix line by line, and a field-sequential scanning method scanning all the pixels arranged in matrix at once. Although the image display unit 304 of the display apparatus 300 includes the row driving unit 308 and the column driving unit 310 in FIG. 10, the present exemplary embodiment is not limited thereto, and the display apparatus 300 may include only one driving unit.

The power supply unit 312 supplies power to the row driving unit 308 and the column driving unit 310, and applies a voltage to the row driving unit 308 and the column driving unit 310. The magnitude of the voltage applied to the row driving unit 308 and the column driving unit 310 by the power supply unit 312 varies depending on an image signal adjusted by the image signal adjusting unit 302.

The display control unit 314 includes an MPU, sends a control signal for applying a voltage determining whether to turn on or off of a pixel to one of the row driving unit 308 and the column driving unit 310 according to the image signal adjusted by the image signal adjusting unit 302, and sends an image signal to the remaining one of the row driving unit 308 and the column driving unit 310. Also, the display control unit 314 may control the power supply unit 312 to supply power to the row driving unit 308 and the column driving unit 310 according to the image signal adjusted by the image signal adjusting unit 302.

The display apparatus 300 constructed as shown in FIG. 10 can adjust an input image signal and display an image on the basis of the adjusted image signal.

As described above, the display apparatus 300 may include the image signal adjusting unit 302 having the same function and construction as that of the apparatus 100 or the apparatus 200. Accordingly, the display apparatus 300 can judge a correlation between a current frame and a preceding frame on the basis of an input image signal and control a gain of an image signal and a light emission time on the basis of the judged correlation. Also, the display apparatus 300 includes the image display unit 304 including the light emitting element that emits light in response to flowing current such as the organic EL element. Accordingly, the display apparatus 300 can display an image on the basis of the adjusted image signal.

Hence, the display apparatus 300 can prevent flicker and blur and ensure high image quality by judging the correlation between the current frame and the preceding frame on the basis of the input image signal and controlling the gain of the image signal and the light emission time on the basis of the judged correlation.

Although the display apparatus 300 has been exemplarily explained, the present invention is not limited thereto and any display apparatus including a light emitting element emitting light in response to current, such as an organic EL display or an LCD, may be used. Also, the present exemplary embodiment may be applied to a receiving apparatus for receiving television broadcasting.

A computer-readable medium storing a program for embodying the display apparatus 300 can ensure high image quality by judging a correlation between a current frame and a preceding frame on the basis of an input image signal and controlling a gain of an image signal and a light emission time on the basis of the judged correlation.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although an image signal input to the apparatus 100 of FIG. 3, the apparatus 200 of FIG. 8, and the display apparatus 300 of FIG. 10 may be a digital signal, the present invention is not limited thereto. Each of the apparatus for processing an image signal and the display apparatus according to the present invention may include an A/D converter, convert an input analog signal (image signal) into a digital signal by using the A/D converter, and process the converted image signal. Alternatively, each of the apparatus for processing an image signal and the display apparatus according to the present invention may include elements each of which is an analog circuit and process an analog signal (image signal) by using the analog circuits.

Each of the apparatus 100 of FIG. 3 and the apparatus 200 of FIG. 8 generate two sub frames in one frame period and switch an impulse-type light emission state of FIG. 2A and a hold-type light emission state of FIG. 2B. However, the present invention is not limited thereto. The apparatus for processing an image signal according to the present invention may generate three or more sub frames, and control a gain of an image signal and a light emission time to satisfy Equation 1 so as to switch three or more light emission states.

The present invention may be embodied as computer readable codes on a computer readable recording medium. The computer readable recording medium is any data storage device that can store data which can be thereafter read by a computer system. Examples of the computer readable recording medium include ROMs, RAMs, compact disk (CD)-ROMs, magnetic tapes, floppy disks, and optical data storage devices.

As described above, since a correlation between a current frame and a preceding frame is judged on the basis of an input image signal and a gain of an image signal and a light emission time are controlled on the basis of the judged correlation, the present invention can ensure high image quality.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for processing an image signal, the apparatus comprising:
a sub frame generating unit which outputs an input signal a plurality of times in one frame period and generates a plurality of sub frames in the one frame period;
a correlation judging unit which determines whether there is a correlation between a current frame which is represented by the input image signal for every sub frame and a preceding frame for every corresponding pixel; and
a frame distributing unit which adjusts a gain of an image signal corresponding to each pixel for every sub frame based on a result of the determination by the correlation judging unit, and outputs the image signal adjusted for every sub frame in a period corresponding to each of the sub frames.

2. The apparatus of claim 1, wherein the frame distributing unit comprising:
an amplifying unit which amplifies the input image signal by a amplification factor;
a first switching unit which selectively outputs at least one of the image signal amplified by the amplifying unit, the input image signal, and a signal having a signal level of 0 for every sub frame based on the determination by the correlation judging unit; and
a second switching unit which selectively outputs a signal output for every sub frame from the first switching unit in a period corresponding to each of the sub frames.

3. The apparatus of claim 2, wherein the first switching unit outputs the input image signal for every sub frame if the correlation judging unit determines that there is a correlation, and outputs the image signal amplified by the amplifying unit or the signal having the signal level of 0 for every sub frame if the correlation judging unit judges that there is no correlation.

4. The apparatus of claim 1, wherein the frame distributing unit maintains a light output in one frame period at the same level between if the correlation judging unit determines that there is a correlation and if the correlation judging unit determines that there is no correlation.

5. The apparatus of claim 1, wherein the correlation judging unit comprises:
a frame memory which stores the input image signal for one frame period; and
a comparing unit which compares an image signal corresponding to the current frame with an image signal output from the frame memory and corresponding to the preceding frame for every corresponding pixel.

6. An apparatus for processing an image signal, the apparatus comprising:
a correlation judging unit which determines whether there is a correlation between a current frame represented by an input image signal and a preceding frame for every corresponding pixel;
a gain adjusting unit which adjusts a gain of an image signal corresponding to each pixel based on a result of the determination by the correlation judging unit;
a sub frame generating unit which outputs the image signal adjusted by and output from the gain adjusting unit a plurality of times in one frame period and generates a plurality of sub frames in the one frame period; and
a frame distributing unit which outputs the image signal output for every sub frame from the sub frame generating unit in a period corresponding to each of the sub frames.

7. The apparatus of claim 6, wherein the gain adjusting unit comprises:
an amplifying unit which amplifies the input image signal; and
a switching unit which selectively outputs one of the image signal amplified by the amplifying unit, the input image signal, or a signal having a signal level of 0 for every sub frame based on the result of the determination by the correlation judging unit.

8. The apparatus of claim 7, wherein the sub frame generating unit comprises a plurality of sub frame generating units which synchronize and output signals output for every corresponding sub frame from the switching unit a plurality of times in one frame period.

9. A method of processing an image signal, the method comprising:
outputting an input image signal a plurality of times in one frame period and generating a plurality of sub frames in the one frame period;
determining whether there is a correlation between a current frame which is represented by the input image signal for every sub frame and a preceding frame for every corresponding pixel;
adjusting a gain of an image signal corresponding to each pixel for every sub frame on based on a result of the determining; and
outputting the image signal adjusted for every pixel frame in a period corresponding to each of the sub frames.

10. A method of processing an image signal, the method comprising:
determining whether there is a correlation between a current frame represented by an input image signal and a preceding frame for every corresponding pixel;
adjusting a gain of an image signal corresponding to each pixel based on a result of the determining;
outputting the adjusted image signal a plurality of times in one frame period and generating a plurality of sub frames in the one frame period; and
outputting the image signal for every sub frame in a period corresponding to each of the sub frames.

11. A computer-readable recording medium having embodied thereon a program for executing a method of processing an image signal, the method comprising:
outputting an input signal a plurality of times in one frame period and generating a plurality of sub frames in the one frame period;
determining whether there is a correlation between a current frame which is represented by the input image for every sub frame and a preceding frame for every corresponding pixel;
adjusting a gain of an image signal corresponding to each pixel for every sub frame based on a result of the determining; and
outputting the image signal adjusted for every sub frame in a period corresponding to each of the sub frames.

12. A computer-readable recording medium having embodied thereon a program for executing a method of processing an image signal, the method comprising:
determining whether there is a correlation between a current frame represented by an input image signal and a preceding frame for every corresponding pixel;
adjusting a gain of an image signal corresponding to each pixel based on a result of the determining;
outputting the adjusted image signal a plurality of times in one frame period and generating a plurality of sub frames in the one frame period; and
outputting the image signal for every sub frame in a period corresponding to each of the sub frames.

13. A display apparatus comprising:
an image signal adjusting unit which adjusts a gain of an image signal and a light emission time in one frame period based on an input image signal; and
an image display unit which comprises a plurality of pixels, which have light emitting elements self-emitting light in response to current and are arranged in matrix, and displays an image based on the image signal adjusted by the image signal adjusting unit,
wherein the image signal adjusting unit comprises:
a sub frame generating unit which outputs an input image a plurality of times in one frame period and generates a plurality of sub frames in the one frame period;
a correlation judging unit which determines whether there is a correlation between a current frame which is represented by the input image signal for every sub frame and a preceding frame for every corresponding pixel; and
a frame distributing unit which adjusts a gain of an image signal corresponding to each pixel for every sub frame based on a result of the determination by the correlation judging unit, and outputs the image signal adjusted for every sub frame in a period corresponding to each of the sub frames.

14. A display apparatus comprising:
an image signal adjusting unit which adjusts a gain of an image signal and a light emission time in one frame period based on an input image signal; and
an image display unit which comprises a plurality of pixels, which have light emitting elements self-emitting light in response to current and are arranged in matrix, and displays an image based on the image signal adjusted by the image signal adjusting unit,
wherein the image signal adjusting unit comprises:
a correlation judging unit which determines whether there is a correlation between a current frame represented by an input image signal and a preceding frame for every corresponding pixel;
a gain adjusting unit which adjusts a gain of an image signal corresponding to each pixel based on a result of the determination by the correlation judging unit;
a sub frame generating unit which outputs the image signal adjusted by and output from the gain adjusting unit a plurality of times in one frame period, and generates a plurality of sub frames in the one frame period; and
a frame distributing unit which outputs the image signal output for every sub frame from the sub frame generating unit in a period corresponding to each of the sub frames.
